(19) United States
(12) Patent Application Publication
(10) Pub. No.: US 2017/0023920 A1
(43) Pub. Date: Jan. 26, 2017

(54) IMPROVED METHOD FOR TESTING A CONTROL SYSTEM

(71) Applicant: MHWirth AS, Kristiansand (NO)

(72) Inventors: WITOLD PAWLUS, ARENDAL (NO); SOEREN OEYDNA, KRISTIANSAND (NO); FRED LILAND, KRISTIANSAND (NO); CHRISTIAN IVAR INOUVA, KRISTIANSAND (NO)

(73) Assignee: MHWIRTH AS, KRISTIANSAND (NO)

(21) Appl. No.: 15/124,356

(22) PCT Filed: Feb. 23, 2015
(86) PCT No.: PCT/EP2015/053682

§ 371 Date: Sep. 8, 2016

(30) Foreign Application Priority Data
Mar. 10, 2014 (NO) 20140308

(51) Int. Cl. G05B 17/02

(52) U.S. Cl. CPC G05B 17/02

(57) ABSTRACT

A method for providing a real-time testing of a control system or a part thereof to control a process or a part thereof of a real world system. The method includes connecting the control system or the part thereof to a real-time simulator to simulate the real world system, providing a simulation of the real world system in real-time by applying a modified variable step-size solver, and monitoring a real-time performance of the real-time simulator and adapting step-sizes used for the modified variable step-size solver to run the simulation by comparing a time used by the modified variable step-size solver to simulate the real world system with a real-time clock, setting a maximum step-size of the modified variable step-size solver based on a sample rate of the control system, and forcing the modified variable step-size solver to return a simulation result when demanded by the control system.

### CROSS REFERENCE TO PRIOR APPLICATIONS

This application is a U.S. National Phase application under 35 U.S.C. §371 of International Application No. PCT/EP2015/053682, filed on Feb. 23, 2015 and which claims benefit to Norwegian Patent Application No. 20140308, filed on Mar. 10, 2014. The International Application was published in English on Sep. 17, 2015 as WO 2015/135740 A1 under PCT Article 21(2).

### FIELD

The present invention relates to a method for testing a control system. More specifically, the present invention relates to an improved method for the real-time testing of a control system controlling a complex real world system.

### BACKGROUND

Control systems typically comprise a combination of hardware and software for controlling a physical system, also called a real world system. The hardware comprises a device to interface to the real world system it is controlling, and the software manages the operations by generating signals to control the real world system via the interface.

Testing of the control system can be performed by simulation software simulating the real world system. Bugs in the controller software can then be detected and corrected. Testing also involves ensuring that the software gives the desired functionality to the user.

Conventional methods of testing controllers include static testing where the controller is tested separately from the real world system that it is designed to control. Such techniques cannot, however, provide the same results and efficiency as real-time testing of control systems. Real-time means the actual elapsed time.

Real-time software systems have strict timing constraints and have a deterministic behavior. This is because real-time software systems must schedule their tasks so that timing constraints imposed thereon are met. A conventional static way of testing is not adequate to deal with such timing constraints. Real-time testing is thus important.

Real-time testing of control systems is a technology which is well explored in industries such as the automotive industry or the aerospace industry. Real-time testing has recently also been applied in the offshore drilling industry which is driven by increased complexity of machinery, strict commissioning time requirements, and the level of severity in case of failures.

A real-time test system can be characterized as a simulated process which replaces the controlled process either fully or partially, and which is operated with real control hardware such as, for example, a Programmable Logic Controller (PLC). Real-time testing systems are also known as real-time hardware in the loop (HIL) testing.

The concept of real-time testing is illustrated in FIG. 1 which shows that the control system is connected to either a real world machine or to a model simulating the machine.

Real-time simulation testing means that a virtual model of a real world system is simulated at the same time-rate as the actual real world machine. Stated differently, the simulation time used by a computer to execute a simulation of a process performed by a system is the same as the real-time elapsed for the process.

Prior art methods for real-time testing of control systems are characterized by simulations of machinery and processes realized in an environment which are only similar to real-time, or models of offshore machinery which are relatively simple and that are easily simulated on a typical computer.

There is therefore a need for a method which provides realistic real-time testing of complex control systems. In order to perform real-time testing, it is vital to assess if the simulation time is equal to the time elapsed by monitoring real-time performance of a simulator.

### SUMMARY

An aspect of the present invention is to provide an improved method for providing real-time performance of a simulation for testing a control system connected to a complex real world system.

In an embodiment, the present invention provides a method for providing a real-time testing of a control system or a part of the control system to control a process or a part of the process of a real world system. The method includes connecting the control system or the part of the control system to a real-time simulator to simulate the real world system, providing a simulation of the real world system in real-time by applying a modified variable step-size solver, and monitoring a real-time performance of the real-time simulator and adapting step-sizes used for the modified variable step-size solver to run the simulation by comparing a time used by the modified variable step-size solver to simulate the real world system with a real-time clock, setting a maximum step-size of the modified variable step-size solver based on a sample rate of the control system, and forcing the modified variable step-size solver to return a simulation result when demanded by the control system.

### BRIEF DESCRIPTION OF THE DRAWINGS

The present invention is described in greater detail below on the basis of embodiments and of the drawings in which:

FIG. 1 illustrates the set-up for real-time testing; and

FIG. 2 illustrates the components of a real-time simulator.

### DETAILED DESCRIPTION

The present invention is defined by a method for providing real-time testing of a control system or at least one part of a control system to control a process or at least a part of a process of a real world system.

The control system or the at least a part of the control system is connected to a simulator for simulating the real world system.

The real world system is simulated in real-time by applying a modified variable step-size solver.

Real-time performance of the simulator is monitored, and step-sizes used for the modified variable step-size solver for running the simulation are adapted by:
comparing the time used by the solver to simulate the real world system with a real-time clock;
setting the maximum step-size of the solver based on the sample rate of the control system; and
forcing the solver to return a simulation result when the control system demands it.

The present invention will be described in detail below with reference to the drawings.

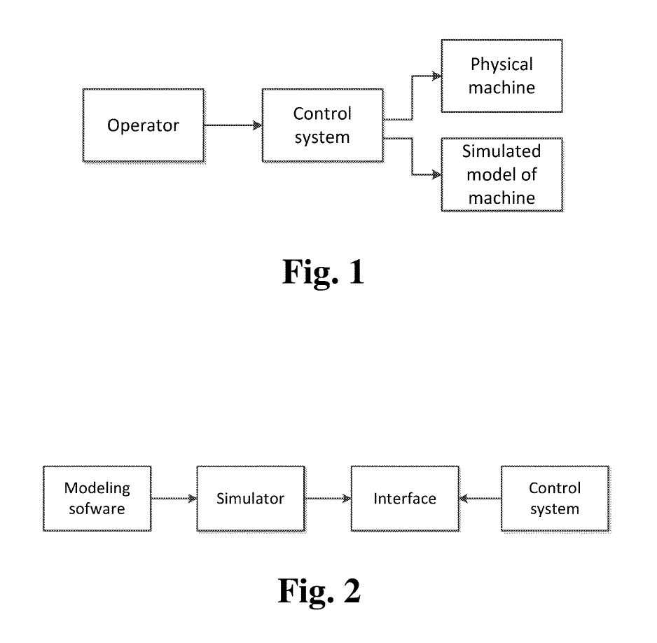

FIG. 1 shows the set-up of the elements for real-time testing where the control system can be connected either to the real world machine or to the model simulating the machine.

The controller will send the same controlling signals to a real world machine to be controlled or to a simulator simulating the real world machine. The control system will thus not be able to differentiate between the two.

FIG. 2 shows the two main components of a real-time simulator and their connections to the real control system controlling a real world system. The simulator is a hardware device such as, for example, a computer running modeling software with all modules necessary to simulate a specific real world system.

The present invention comprises a method to provide for the real-time testing of a control system connected to and configured to control a complex real world system. A complete control system for controlling a real world system can thereby be tested, or at least a part of a control system for controlling at least a part of a process of a real world system. A process to be controlled includes a continuous, a discrete, and a batch process.

The control system for controlling the real world system is connected to a simulator for simulating the real world system. They are either connected via an interface or are directly connected to each other. The control system to be tested is the same as the one controlling the real world system.

In an embodiment of the present invention, the real world system can, for example, be offshore drilling equipment. Other types of systems are also feasible.

In an embodiment of the present invention, the real-time simulator can, for example, run on a computer. In another embodiment of the present invention, the real-time simulator can, for example, run on dedicated testing hardware. In yet another embodiment of the present invention, the real-time simulator can, for example, run on a controller other than the real-time controller that is tested.

When the control system to control the real world system, or at least a part of it, is connected to a simulator to simulate the real world system, or at least a process of the real world system, the real world system is simulated in the simulator in real-time by applying a modified variable step-size solver that will be explained below.

The type of solver used is the main factor which decides if a large simulation model can be utilized in a real-time test. In order to solve a given mathematical problem comprised in a simulation model, the solver splits the whole simulation into small portions, so called step-sizes. There are in principle two types of solvers: one is the fixed step-size solver, and the other is the variable step-size solver.

The fixed step-size solver keeps constant time steps during code execution. This is, however, problematic if a high level of accuracy for a simulation is required or if a large model is to be simulated.

The variable step-size solver, on the other hand, adjusts the step-size throughout the calculation to provide that both a satisfactory level of accuracy and an increased computational efficiency are achieved.

The present invention comprises a method for combining the benefits of the two solvers and developing what is called a modified variable step-size solver which allows for accurate simulation of large models and simultaneously enables real-time execution.

In order to verify real-time performance of a simulation, the elapsed simulation time used by the solver to simulate the real world system and the time are measured and compared by subtraction. A convenient factor for measuring real-time performance of an application is the total delay, i.e., the difference between the real-time and the simulation time. It is expected that this value is constant and close to zero throughout a simulation for a real-time application.

As stated above, the real world system is simulated in real-time by applying a modified variable step-size solver. While the simulator is running, real-time performance of the simulator is monitored and step-sizes used for the modified variable step-size solver to run the simulation are continuously adjusted and adapted.

The time used by the solver to simulate the real world system with a real-time clock is compared. If subtracting the simulation time from the elapsed time yields a positive value (for example, computing 1 minute of simulation takes 10 minutes), the simulated system is too complex and too slow to be used in a real-time hardware in the loop (HIL) test. This is a typical situation when a detailed model of a system applied in offline simulations is directly exported to a real-time simulator. This setting is problematic if a high level of accuracy is required or if a large model is to be simulated. This normally also occurs if a fixed step-size solver is used. If a simulator lags behind the real-time, it cannot be used in real-time HIL tests. A solution is to simplify a complex model and to make it run in real-time with an acceptable level of accuracy. Simplifying a model is, however, not always possible or desirable.

If subtracting the simulation time from the elapsed time yields a negative value (for example, computing 10 minutes of simulation takes only 1 minute), the simulated system is too fast and cannot be used in a real-time HIL test. Such a model is not suitable for real-time simulation due to the time stamps discrepancies even if the obtained results are accurate. However, since it is confirmed that such a simulation yields accurate enough results, the concern is its real-time performance which could be achieved by limiting the maximum step-size of a solver. The parameters and step-sizes will depend on model complexity and the desired level of accuracy. This situation is less problematic than the example above.

If a solver has the results of a simulation ready faster than the real-time, it will wait for the next cycle to begin. This is achieved by setting the maximum step-size of the modified variable step-size solver to a value which will prevent the solver from going faster than the real-time.

Decreasing step sizes means running more parts of a simulation model giving more accurate results, and increasing step sizes means running fewer parts of a simulation model giving less accurate results.

The real-time clock of the real world system will define an upper limit for maximum time the solver can use. This upper limit will provide an input to the simulator running the modified variable step size solver.

The present invention also sets the maximum step size of the solver based on the sample rate of the controller.

The last step of the inventive method is to force the solver to return the simulation result when demanded by the controller based on the elapsed real-time. The solver can also return the corresponding simulation accuracy level.

The accuracy levels of the simulation result are calculated using local truncation error techniques which are commonly used in solver algorithms.

The simulation model may be too complex for real-time testing if the simulation accuracy levels are considered to be too low.

The inventive method comprising the different steps defined above will provide that the simulation will be run in real-time and that the accuracy of the simulation result will be presented.

Using a modified variable step-size solver according to the present invention realizes accurate simulations of large models running in real-time.

The inventive method is a significant step forward in the field of real-time testing, and is well suited for real-time testing of control systems for real world hydraulic-mechanical systems used, for example, on drilling rigs. Simulations of machinery involving real control systems have to date only been realized in this area in an environment which is at best close to real-time or with models of offshore machinery that are relatively simple and easily simulated.

The inventive method is also well suited for real-time testing of a control system for a real world electrical system or for real-time testing of the control system for a real world system comprising a combination of mechanical and electrical systems.

By using the inventive method, there is no need to explicitly formulate a detailed set of mathematical equations describing the system to be simulated. The model can instead be created directly in a virtual simulation environment by using standard multi-domain libraries and components. The solver can then use libraries and modules which emulate the real world behavior of the real world system.

Such a testing framework will offer improvements over existing solutions in terms of simulation fidelity and accuracy levels as well as modeling efficiency and complexity.

The inventive method can be successfully applied for testing and examining real control systems of large machines in a virtual simulation environment, and provides good scalability for different hardware platforms.

The present invention is not limited to embodiments described herein; reference should be had to the appended claims.

What is claimed is:

1-8. (canceled)

9. A method for providing a real-time testing of a control system or a part of the control system to control a process or a part of the process of a real world system, the method comprising:
connecting the control system or the part of the control system to a real-time simulator to simulate the real world system;
providing a simulation of the real world system in real-time by applying a modified variable step-size solver; and
monitoring a real-time performance of the real-time simulator and adapting step-sizes used for the modified variable step-size solver to run the simulation by:
comparing a time used by the modified variable step-size solver to simulate the real world system with a real-time clock;
setting a maximum step-size of the modified variable step-size solver based on a sample rate of the control system; and
forcing the modified variable step-size solver to return a simulation result when demanded by the control system.

10. The method as recited in claim 9, wherein the modified variable step-size solver further returns a simulation accuracy level.

11. The method as recited in claim 9, wherein the control system is connected to the real-time simulator via an interface.

12. The method as recited in claim 9, wherein the control system is directly connected to the real-time simulator.

13. The method as recited in claim 9, wherein the real-time simulator is configured to run on a computer.

14. The method as recited in claim 9, wherein the real-time simulator is configured to run on dedicated testing hardware.

15. The method as recited in claim 9, wherein the real-time simulator is configured to run on a control system other than the control system tested.

16. The method as recited in claim 9, wherein the modified variable step-size solver uses libraries and modules which emulate a real world behavior of the real world system.
